(19) United States
(12) Patent Application Publication
(10) Pub. No.: US 2012/0005917 A1
(43) Pub. Date: Jan. 12, 2012

(54) SHEET-PROCESSING MACHINE WITH ONE OR MORE DRYERS AND METHOD FOR DRYING SHEETS

(75) Inventors: JOCHEN JUNG, LOERRACH (DE); ROLF MUELLER, NUSSLOCH (DE)

(73) Assignee: HEIDELBERGER DRUCKMASCHINEN AG

(21) Appl. No.: 13/177,659

(22) Filed: Jul. 7, 2011

(30) Foreign Application Priority Data
Jul. 9, 2010 (DE) 10 2010 026 604.3

(51) Int. Cl. F26B 21/08; F26B 3/02

(52) U.S. Cl. 34/448; 34/548

(57) ABSTRACT

A sheet-processing machine includes at least one dryer, air feed devices for the dryers, at least one air extraction device for heated exhaust air and a mixing device for mixing warm dryer exhaust air with the dryer feed air. An open loop or closed loop control device controls or regulates an extent to which the dryer exhaust air is mixed with the dryer feed air by using measured variables or setting values which are correlated with the moisture content of the exhaust air. A method for drying printed and/or varnished sheets is also provided.

### CROSS-REFERENCE TO RELATED APPLICATION

This application claims the priority, under 35 U.S.C. §119, of German Patent Application DE 10 2010 026 604.3, filed Jul. 9, 2010; the prior application is herewith incorporated by reference in its entirety.

### BACKGROUND OF THE INVENTION

### Field of the Invention

The invention relates to a method for drying printed and/or varnished sheets in a sheet-processing machine as well as to a sheet-processing machine, in particular a sheet-fed printing press, including one or more dryers, air feed devices for the dryers, air extraction devices for the heated exhaust air and a mixing device for mixing part of the exhaust air with the dryer feed air.

Sheet-fed printing presses of that type are known per se. With rising energy prices, it has become more and more important to optimize the energy consumption of printing presses and, in particular in the area of the dryer, which has a high energy consumption in comparison with other components of the machine, to find measures for reusing the exhaust air heated up in the dryer and the heat contained therein. For instance, it is known from German Patent Application DE 10 2004 048 857 to mix warm exhaust air from part of a sheet-fed offset printing press with feed air from another part of the printing press and to feed it to a dryer in the printing press. Other proposals are aimed at heating the dryer feed air through heat exchangers, which are operated by exhaust heat from the printing press, including the warm dryer exhaust air. Such devices are described, for example, in European Patent Application EP 2 047 991 A2, German Patent Application DE 10 2005 042 956 A1 or International Publication No. WO 01/68223 A1, corresponding to U.S. Pat. No. 6,868,788.

Furthermore, it is also known from European Patent EP 1 319 506 B1 to provide movable flaps, with which the residence time of warm air in the dryer is controlled in order to bring the latter quickly to an optimal operating temperature. That control is carried out by measuring the temperature in the area of the dryer.

The known devices are, to some extent, associated with very high additional expenditure for equipment, in particular the one described in the aforementioned International Publication No. WO 01/68223 A1, corresponding to U.S. Pat. No. 6,868,788. Nevertheless, it is not ensured that the dryer exhaust air is used optimally.

### SUMMARY OF THE INVENTION

It is accordingly an object of the invention to provide a sheet-processing machine with one or more dryers and a method for drying sheets, which overcome the hereinafore-mentioned disadvantages of the heretofore-known devices and methods of this general type and which provide equipment for sheet-processing machines with which a significant contribution can be made in a simple and cost-effective way toward increasing the energy efficiency of a dryer.

With the foregoing and other objects in view there is provided, in accordance with the invention, a sheet-processing machine, in particular a sheet-fed printing press, comprising at least one dryer, air feed devices for the at least one dryer, at least one air extraction device for heated dryer exhaust air, a mixing device for mixing the heated dryer exhaust air with the dryer feed air, and an open loop or closed loop control device controlling or regulating an extent of mixing of the dryer exhaust air with the dryer feed air by using measured variables or setting values correlated with a moisture content of the dryer exhaust air.

The invention is based on the finding that it is not merely sufficient to perform temperature measurements in order to control the air management in a dryer. Instead, the extent to which warm exhaust air that is fed back can be used once more to dry the moist sheet depends on how highly the exhaust air is already saturated with water vapor. Therefore, the invention proposes to control or to regulate the proportion of circulated air, i.e. that part of the exhaust air which is fed back to the dryer feed air or, expressed in other words, the extent to which the dryer exhaust air is mixed in, in accordance with the absolute humidity of the exhaust air. For this purpose, one or more preferably motor driven mixing valves can expediently be used, as are to some extent already present but normally without motorized activation.

The open loop or closed loop control device which controls the extent to which the dryer exhaust air is mixed in is expediently additionally connected to sensors for measuring the temperature of the dryer exhaust air, since, through the use of the simultaneous measurement of temperature and relative humidity, the quantity of water vapor contained in the exhaust air can be determined. Corresponding characteristic curves, through the use of which the mixing ratio is then controlled and regulated, can be stored in the controller.

It can also be expedient in addition to provide sensors which also measure the atmospheric humidity and/or temperature of the dryer feed air. This is because the quantity of partly moist exhaust air fed in, in particular when the feed air is taken unfiltered from the press room or the surroundings, may also depend on how high the atmospheric humidity of the surroundings already is. The control/regulation and therefore the proportion of recirculated air that is fed back from the dryer exhaust air is chosen in such a way that the energy efficiency is high and, nevertheless, the drying is not substantially impaired, due to the water absorption capacity that is still present. The efficiency of the drying operation can be determined, for example, in a Mollier diagram by using a so-called edge scale.

It is not necessary to adjust the mixing valve in the mixing device continuously. It is sufficient if the mixing valve can be adjusted in discrete stages, with it being possible for the output signal from the open loop or closed loop control device to be generated by comparison with fixed stored threshold values, for example as a signal with a staircase waveform or pulse-like waveform for driving stepping motors.

The sheet-processing machine equipped in accordance with the invention, for example a sheet-fed offset printing press, can have dryers of different types, with it being possible for the exhaust air from a dryer to be mixed with the feed air of a dryer of another type. However, it is also possible in the same way to carry out the measures described in a dryer of the same type or in the same dryer.

Further advantages in relation to the energy efficiency result if the waste heat from the part of the dryer exhaust air that is not fed back is fed to other additional devices in the machine, in which the exhaust air can be used expediently. In this case, this can be one or more heat exchangers, for example, over which the parts of the dryer exhaust air that are not fed directly to the dryer feed air are led. As a rule, additional measures are needed for such further improvements in the energy efficiency and the expenditure therefor generally rises with a higher desired level or extent of the efficiency. In a further step, for example, a heat exchanger can heat the dryer feed air, preferably at a point before the dryer exhaust air is mixed with the dryer feed air. This heat exchanger can be operated with the exhaust air that is not fed back or else through the use of the waste heat which is produced, for example, by sheet-carrying elements or impression cylinders in the area of the dryer. However, by using the dryer exhaust air that is not fed back, it is also possible for other regions of the sheet-processing machine to be supplied with process heat, for example back-pressure or impression cylinders having a temperature which can be controlled, which are used for the purpose of preheating the printed sheet before entry into the respective dryer area, as described for example in German Patent Application DE 10 2007 056 899 A1, corresponding to U.S. Patent Application Publication Nos. US 2008/0134915 and US 2009/0277352, the full contents of which are incorporated herein by reference at this point.

The dryer exhaust air is used quite particularly efficiently if the part of the dryer exhaust air that is not fed back directly and the dryer feed air are in each case led over two heat exchangers, with it being possible for the first heat exchanger in the flow direction to be a simple air-air heat exchanger, while the heat exchanger following in the flow direction in each case is connected to a compressor which connects the two heat exchangers following in the flow direction to each other in the area of the dryer exhaust air and the dryer feed air. In this way, the exhaust air, for example blown into the open, can be cooled down until within the range of the surrounding air, while the energy content is simultaneously raised through the compressor in accordance with the principle of the heat pump to a temperature level from which only very little electrical energy is still needed by the heating matrices in order to bring the air to the temperature required for the drying. As a result, the compressor undertakes the task of the heating matrices, but with a very much higher efficiency. At the same time, as a result of the cooling of the moist warm dryer exhaust air, the temperature falls below the dew point, so that it is easily possible at this point to provide devices for dewatering and/or for removing solvents from the dryer exhaust air. The exhaust air dewatered and/or made free of solvents in this way can consequently be fed to the feed air through a second circuit or the result is a closed system without emissions.

Other features which are considered as characteristic for the invention are set forth in the appended claims.

Although the invention is illustrated and described herein as embodied in a sheet-processing machine with one or more dryers and a method for drying sheets, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWINGS

FIG. 1 is a diagrammatic, longitudinal-sectional view of an in-line offset printing press;

FIG. 2 is a schematic and block diagram of a control for a dryer in a delivery;

FIG. 3 is a schematic and block diagram of another embodiment of a control for a dryer;

FIG. 4 is a Mollier diagram illustrating an efficiency of energy use of a dryer;

FIG. 5 is a diagram in which a level of drying is plotted against an overall efficiency of the dryer; and

FIG. 6 is a schematic and block diagram of a control for a dryer using a heat exchanger.

### DETAILED DESCRIPTION OF THE INVENTION

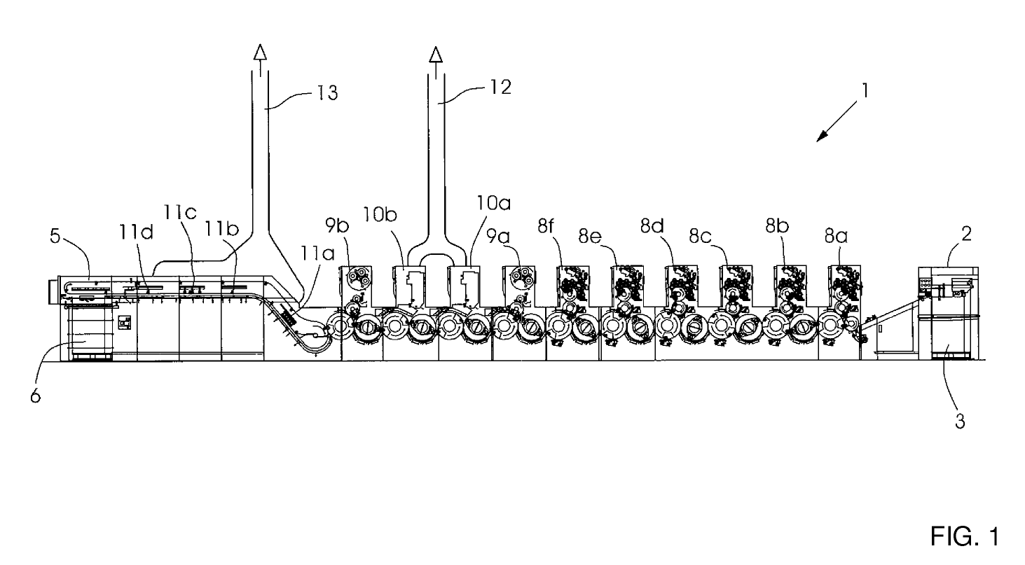

Referring now to the figures of the drawings in detail and first, particularly, to FIG. 1 thereof, there is seen an offset printing press 1 with an in-line construction. The printing press 1 has a feeder 2, in which an unprinted paper stack 3 is located, six printing units 8a to 8f for four primary colors and, if appropriate, two further spot colors, a first varnishing unit 9a, two dryer units 10a and 10b downstream thereof, a second varnishing unit 9b and a delivery 5 having a sheet delivery stack 6. In a region of chain guides of the delivery 5, four further dryer units 11a to 11d are disposed one after another in a sheet transport direction.

A printing press of this type is, for example, offered by Heidelberger Druckmaschinen AG under the designation Speedmaster XL105-6-LYYLX3.

In the dryer units 10a and 10b, fresh air which is blown in is subsequently heated by heating matrices. An exhaust air duct 12, which is illustrated above the dryer devices 10a and 10b, has a blower which extracts moist warm exhaust air from the dryer unit and leads it out of the press room or print shop into the open through a non-illustrated pipeline system.

The dryers 11a-11d in the delivery 5 of the printing press 1 are implemented in the form of cassette-like withdrawable units. These withdrawable dryer units can be hot air dryers, infrared dryers, UV dryers or so-called combined dryers, which act on the sheet to be dried both with hot air and with radiation energy. The exhaust air from the withdrawable dryer units 11a-11d is led into the open through an exhaust air duct 13, which is likewise illustrated in the figure.

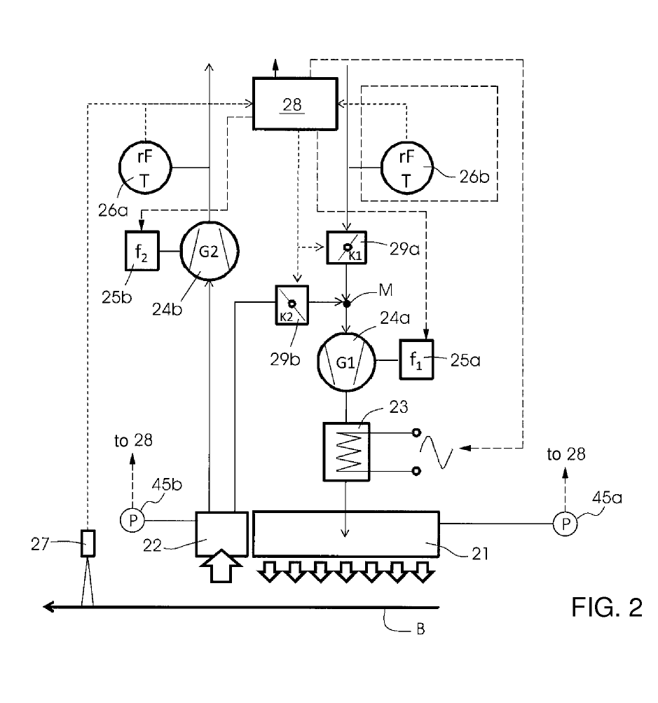

A first exemplary embodiment of the invention will be explained in more detail by using a simplified electromechanical block diagram in FIG. 2, in which reference numeral 21 designates one of the withdrawable dryer units in the delivery 5. The dryer unit 21 is supplied with hot air through a blower 24a and a heating matrix 23. It is possible for a rotational speed of the blower 24a to be controlled by a controller 28 in accordance with a pressure p in the dryer 21, which is supplied by a pressure sensor 45a. A first throttle valve 29a is also disposed in the feed air duct upstream of the blower 24a, to be specific upstream of a point M in terms of flow at which part of the heated exhaust air from the dryer 21 is fed into a feed air through a second throttle valve 29b. A blower 24b, which is disposed in an exhaust air duct 22, has a drive 25b which is likewise controlled in terms of its rotational speed by the controller 28 in accordance with a pressure p, which is signaled by a second pressure sensor 45b in the exhaust air duct. Furthermore, a sensor unit 26a, which is disposed in the exhaust air duct downstream of the blower 24b, contains a humidity sensor rF and a temperature sensor T. Output signals from the two sensors are fed to the controller 28. A further combined humidity and temperature sensor 26b, which is also connected to the controller 28, is disposed in the feed air duct on the flow side upstream of the throttle valve 29a. Finally, an output signal from an IR thermosensor 27, which measures a temperature of a sheet B running out of the dryer, is also fed to the controller 28. The controller 28 takes this signal into account in order to control an electric heating output of the heating matrix 23 in such a way that the sheet B is not overheated.

Furthermore, the controller 28 uses the signal from the humidity sensor rF and the temperature sensor T in the combined sensor 26a to determine the extent to which the exhaust air is still able to absorb moisture. In the simplest case, this is done by comparing the measured humidity values with stored values at a specific temperature value in each case. The valves 29a and 29b can then be adjusted by the controller from the result of the comparison and thus the mixing ratio of feed air and exhaust air that is fed in mixed form to the blower 24a at the point M can be changed. An improvement in the control strategy is obtained if, in addition, as illustrated in FIG. 2, the signals from the second combined sensor 26b are also evaluated, i.e. the relative humidity rF and the temperature T of the feed air upstream of a valve K1 are determined. In this case, the controller compares the measured values from the two combined sensors 26a and 26b with each other and controls the positions of the throttle valves 29a and 29b in accordance with a control strategy explained below:

Combined infrared/hot air dryers have four setting variables which it is necessary to optimize:

1. The output from the infrared radiator
2. The temperature of the hot air
3. The quantity of air (blown air) which is blown onto the sheet
4. The proportion of exhaust air which is fed back into the dryer again (recirculated air).

Normally, the output of the infrared radiator and/or the hot air temperature are controlled in such a way that a preset sheet or stack temperature is reached. Furthermore, the quantity of blown air is set to be as high as possible or at least just sufficiently high that there is no detrimental influence of the air stream on the sheet run. According to the invention, the proportion of the recirculated air is now changed, starting from a preset value or standard value, in such a way that the specific energy used per kg of evaporated solvent (water) does not exceed a predefined value. This value describes the efficiency of the dryer process. The value can be determined, on the basis of job data, by computation by making practical assumptions about physical variables entering into the calculation, as explained below. About 2500 kJ are needed in order to evaporate one kg of water, in the ideal case. In the real industrial printing process of a sheet-fed offset printing press, these values frequently lie around 5-10 times higher. This is associated with energy losses but primarily also with the fact that the air masses used for the drying are able to absorb little water vapor, since the warm exhaust air is removed from the process after impinging on the printed sheet once and is replaced by newly heated air. The high quantities of blown air which result from the blown air velocity and the area of the blown air field are, however, absolutely necessary for good drying of emulsified varnish during the relatively short time during which the sheet is in the dryer. However, only a small part of the air blown in reaches the surface of the sheet and only this part is also saturated with solvent (water vapor). This is because the part of the air stream which impinges on a sheet guide plate or cylinder or further machine parts does not pick up any moisture at all. In many cases, this is half or more of the quantity of hot air being used, depending on the sheet format of the sheet running through.

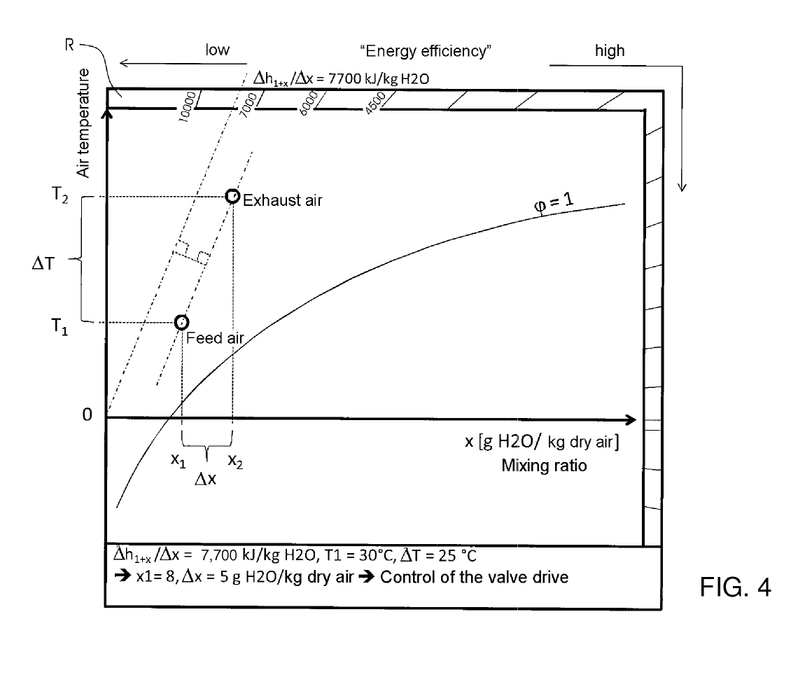

The efficiency of the energy use can now be calculated through the psychometric state variables of the feed and exhaust air. This can be completed geometrically or graphically, for example in a Mollier diagram, which is illustrated in FIG. 4, through a so-called “edge scale,” designated therein by reference symbol R. The evaporation enthalpies are plotted in the edge scale of a Mollier diagram, for example in kJ/kg H₂O. The value used for the drying process is obtained by a point formed by pairs of measured values T₁, the temperature of the feed air, and X₁, the relative humidity of the feed air, being joined by a point formed by a pair of measured values T₂, the temperature of the exhaust air, and the relative humidity X₂ of the exhaust air, by a straight line and the latter being assigned a parallel in the diagram which intersects a zero point of temperature (0° C.) and absolute humidity. The value then reached by this straight line on the edge scale is a measure of the energy used in the drying process and indicates how much energy has been used to evaporate a specific quantity of water from the printing material. The process becomes more efficient when more water vapor is contained in the exhaust air at the same or lower temperature, i.e. when the slope of the straight line connecting the measured values becomes lower. In conventional dryers, the measured values yield evaporation enthalpies of more than 10,000 kJ/kg, i.e. far above four times the theoretical evaporation enthalpy of 2500 kJ/kg water. It is possible to estimate from this to what extent optimizations are possible at this point.

In order to carry out the determination of the evaporation enthalpy it is, of course, possible, instead of the graphical procedure outlined in the Mollier diagram, to determine the evaporation enthalpy by computation through the respective formula and to program this in the controller 28.

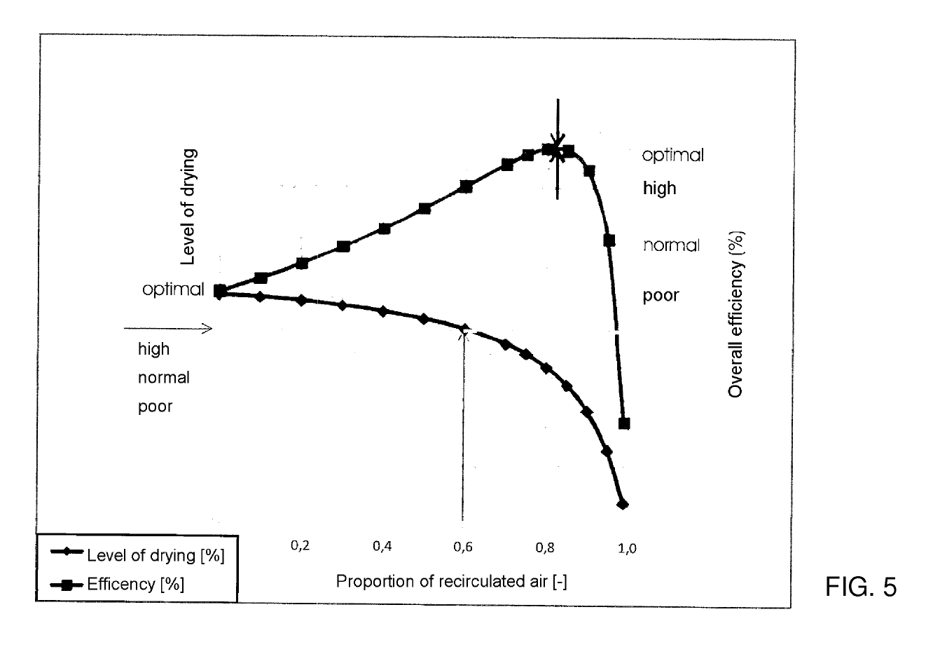

However, it is then not possible to achieve the theoretical value of 2500 kJ/kg water through the higher and higher admixture of exhaust air with feed air, since the more moist exhaust air is mixed with the feed air, the lower the level of drying of the sheet to be dried also becomes. This relationship is illustrated in FIG. 5. There, in the diagram, the coordinate of the level of drying is plotted on the left and the overall efficiency of the dryer is plotted on the right, specifically both as a function of the percentage proportion of recirculated air. The lower curve indicates the level of drying. It runs from the best value with a recirculated air proportion of 0%, i.e. with the recirculation valve closed, falling monotonically more and more sharply to the value 0 at 100%, i.e. with the recirculation valve completely open. On the other hand, the curve plotted above it for the overall efficiency has a maximum, in the example described herein at about 80% opening of the recirculated air valve, and thereafter falls, likewise quickly, to 0 (the latter corresponding to the case in which the recirculated air valve is completely opened, i.e. no more air is removed from the dryer and no more fresh air is fed in which, although it consumes no energy, no longer dries the sheet either).

The course of the two curves depends on very many parameters, with it being possible for the reference points illustrated therein to be determined firstly from humidity and temperature measurements in the exhaust air and feed air of the dryer and on the dried sheet but, secondly, also by using the parameters from a print job. These characteristic curves depend, amongst other things, on the sheet format, the application of varnish to the sheet, the infrared output from the radiator in the combined IR/hot air dryer, the machine speed and the ink coverage of the printed sheet, to name only a few of the most important parameters. In principle, it is therefore also possible, instead of the humidity measurements described previously, to determine the characteristic curves for efficiency and level of drying from these parameters. The operator would then have it in his or her power, as indicated by an arrow at 60% recirculated air, to accept a slight penalty in terms of the level of drying but, in return, to increase the efficiency of the dryer by about 50% and therefore to reduce the required electrical power accordingly.

The controller 28 can, however, also be equipped for various operating modes. For non-critical print jobs, in which for example little varnish or rapidly cross-linking varnish is applied, the proportion of recirculated air can be very high (energy saving mode). On the other hand, in the case of critical print jobs, the operator sets the proportion of recirculated air to be lower, i.e. he or she gives up the energy saving mode or sets it back by one or more steps. Furthermore, it is possible to store in the controller the fact that with blown air temperatures set higher, it is also possible to run with higher proportional quantities of air in the recirculated air (for example at temperatures T>70° C.) than in the case of very moderate air temperatures of, for example, T<60° C. These relationships can also be derived from the Mollier diagram illustrated in FIG. 4.

In general, the controller 28 therefore ensures that the energy efficiency of the dryer is as high as possible but the drying is not substantially impaired, in that the mixture of fresh air and exhaust air formed through the valves 29a and 29b still has a sufficiently high absorption capacity for water.

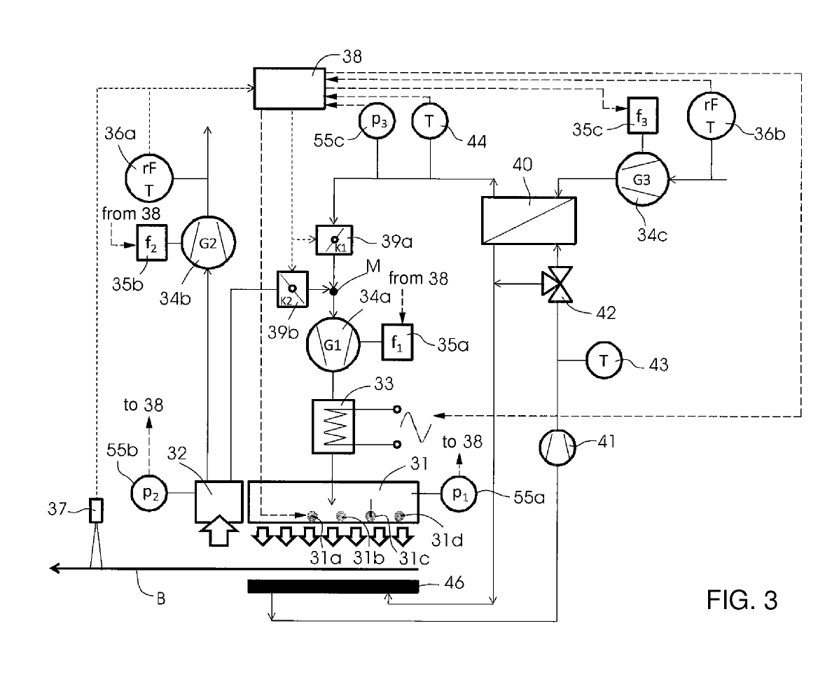

The exemplary embodiment according to FIG. 3 differs from that according to FIG. 2 basically in the fact that an additional air/water heat exchanger 40 is provided in the feed air duct, through which the feed air is forced through the use of a further blower 34c. Otherwise, in comparison with FIG. 2, the same parts are designated with a reference number increased by 10 and will not be explained once more at this point. The withdrawable dryer unit 31 in this case is a so-called combination dryer, to which both hot air is fed through the blower 34 and the heating matrix 33 but which, in addition, contains four infrared radiant heaters 31a to 31d, by which the sheet B running through is irradiated. Reference numeral 46 designates a cooled sheet guide plate, over which the sheet B is drawn without contact by non-illustrated gripper bars driven by transport chains and guided by air cushions. The guide plate 46 is heated up in the dryer both by the hot air and also by the IR radiators 31a to 31d but is cooled by water which is connected to the heat exchanger 40 by a pump 41 through a mixing valve 42. Furthermore, an additional temperature sensor 44, emitting a signal which is likewise fed to the controller 38, is disposed in the feed air downstream of the heat exchanger 40.

Nothing changes in the absolute air humidity of the feed air after passing through the heat exchanger 40, so that the humidity values from the combined sensor 36b for the feed air also continue to apply to the feed air at this point downstream of the heat exchanger. On the other hand, the temperature changes after the passage through the heat exchanger 40, which raises the feed air from the throttle valve 39a to a higher level. Accordingly, the electrical energy for the heating matrix 33 can be reduced, since the feed air already enters the heating matrix 33 at a considerably higher temperature than in the case of the exemplary embodiment according to FIG. 2.

By using the measures described herein, the energy requirement of a dryer can be reduced from typically 100 kW in full operation, i.e. at a machine speed of 16,000 sheets per hour in the 75×105 format, by about 20-30 kW, with the controlled feedback of the exhaust air and the use of the heat exchanger 40 accounting for approximately 10-15 kW in each case. The sheet guide plate 46 or the sheet guide plates in the region of the dryer 31 are blackened, in order to improve the absorption characteristics of the guide plate surface and to increase the effectiveness of the additional feed air heating in this way.

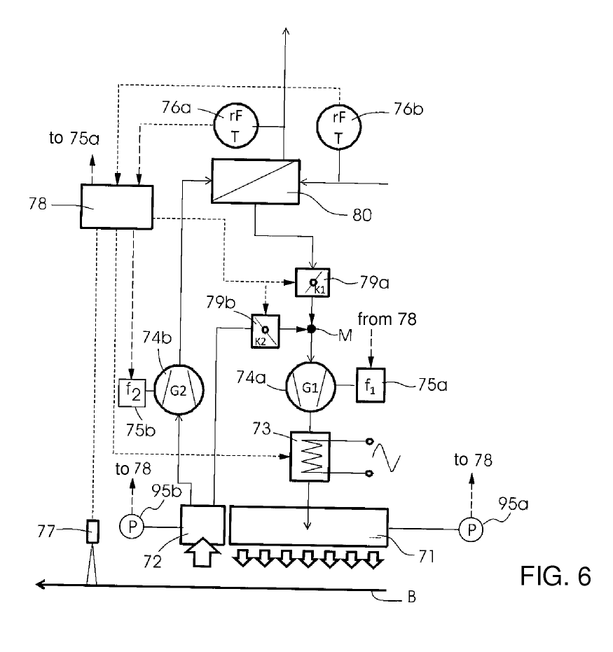

A further reduction in the dryer power by about 10 kW is possible by preheating the sheets to be dried with process heat from exhaust air being transferred to impression or back-pressure cylinders having a temperature which can be controlled, or by the exhaust air that is not fed back transferring part of its heat content to the fresh air through an air/air heat exchanger. This case is illustrated in the embodiment according to FIG. 6. Many functions of the exemplary embodiment according to FIG. 6 correspond to that according to FIG. 2. The same parts are provided with a reference number increased by 50 as compared with FIG. 2 and will therefore not be described once more herein.

In contrast to FIG. 2, however, an air/air heat exchanger 80 is inserted into the exhaust air duct between the blower 74b and the measuring point 76a. Such heat exchangers are offered, for example, by the Klingenberg company in Gladbeck, Germany, under the designation PWT10. The heat exchanger is preferably accommodated between the side walls of the printing press and, in a similar way to the dryers 11a-11d (FIG. 1), can be constructed in the form of a withdrawable unit which can be withdrawn from an appropriate opening in the side wall of the machine, for example for cleaning purposes.

The fresh air fed to the throttle valve 79a is likewise led over the heat exchanger 80 after passing the measuring point 76b and picks up a large part of the heat contained in the exhaust air thereby. The heating power which the heating matrix 73 has to provide is correspondingly lower, as explained above.

1. A sheet-processing machine, comprising:
at least one dryer;
air feed devices for supplying dryer feed air to said at least one dryer;
at least one air extraction device for extracting heated dryer exhaust air from said at least one dryer;
a mixing device for mixing the heated dryer exhaust air with the dryer feed air; and
an open loop or closed loop control device connected to said mixing device and controlling or regulating an extent of mixing of the dryer exhaust air with the dryer feed air by using measured variables or setting values correlated with a moisture content of the dryer exhaust air.

2. The sheet-processing machine according to claim 1, wherein said mixing device includes at least one motor-driven mixing valve to be actuated by said open loop or closed loop control device.

3. The sheet-processing machine according to claim 1, which further comprises:
sensors connected to said open loop or closed loop control device for measuring humidity of the dryer exhaust air;
said open loop or closed loop control device determining the extent of the dryer exhaust air mixed in by using measured values and/or characteristic curves describing a vapor saturation or moisture absorption capacity of the exhaust air.

4. The sheet-processing machine according to claim 3, which further comprises sensors connected to said open loop or closed loop control device for measuring temperature of the dryer exhaust air.

5. The sheet-processing machine according to claim 1, which further comprises sensors connected to said open loop or closed loop control device for measuring atmospheric humidity and/or temperature of the dryer feed air.

6. The sheet-processing machine according to claim 2, wherein:
said at least one mixing valve is adjustable in discrete steps; and
said open loop or closed loop control device emits an output signal to be generated directly or indirectly by comparison with stored threshold values.

7. The sheet-processing machine according to claim 1, wherein said at least one dryer includes dryers of different types, and the exhaust air from at least one of said dryers can be mixed with the feed air of at least one of said dryers of the same type and/or a different type or the feed air of the same dryer.

8. The sheet-processing machine according to claim 1, which further comprises devices for further use of the waste heat from part of the dryer exhaust air not being fed directly to the dryer feed air.

9. The sheet-processing machine according to claim 8, wherein said devices for further use of the waste heat include at least one heat exchanger or heat pumps.

10. The sheet-processing machine according to claim 9, wherein said heat exchanger or heat pumps heat the dryer feed air.

11. The sheet-processing machine according to claim 10, wherein said heat exchanger or heat pumps heat the dryer feed air at a location upstream of a point of mixing of the dryer exhaust air with the dryer feed air.

12. The sheet-processing machine according to claim 1, which further comprises:
sheet-carrying elements producing waste heat; and
a heat exchanger receiving the waste heat from said sheet-carrying elements in vicinity of said at least one dryer.

13. The sheet-processing machine according to claim 12, wherein the dryer feed air is heated by said heat exchanger.

14. The sheet-processing machine according to claim 12, wherein the dryer feed air is heated by said heat exchanger and other components of the sheet-processing machine are supplied with process heat.

15. The sheet-processing machine according to claim 12, which further comprises other components of the sheet-processing machine being supplied with process heat.

16. The sheet-processing machine according to claim 1, wherein the sheet-processing machine is a sheet-fed printing press.

17. A method for drying printed and/or varnished sheets in a sheet-processing machine, the method comprising the following steps:
providing a device for mixing warm dryer exhaust air with dryer feed air; and
determining an extent of mixing of the dryer feed air with the dryer exhaust air by using measured variables or setting values correlated with a moisture content of the dryer exhaust air.

18. The method according to claim 17, which further comprises selecting the measured variables as relative humidity measured values and temperature measured values from the dryer exhaust air.

19. The method according to claim 17, which further comprises selecting the measured variables as relative humidity measured values and temperature measured values from the dryer exhaust air and, if appropriate, relative humidity measured values and temperature values from the dryer feed air.

20. The method according to claim 17, which further comprises calculating the setting values from at least one of the following parameters: sheet format, application of varnish, infrared output of dryer radiation, hot air from a heating matrix, machine speed or ink coverage of a printed sheet.
